(19) United States
(12) Patent Application Publication
(10) Pub. No.: US 2023/0131444 A1
(43) Pub. Date: Apr. 27, 2023

(54) SYSTEMS AND METHODS OF DETECTING FRAUDULENT ACTIVITY AT SELF-CHECKOUT TERMINALS

(71) Applicant: Walmart Apollo, LLC, Bentonville, AR (US)

(72) Inventors: Dhanashree Palande, Seattle, WA (US); Bowen Deng, Jersey City, NJ (US); Joshua M. Horowitz, Brooklyn, NY (US); Jason Nichols, New Providence, NJ (US); Niyati Lalit Shah, Jersey City, NJ (US); Samuel B. Jacobson, Brooklyn, NY (US)

(21) Appl. No.: 17/910,503

(22) PCT Filed: Mar. 19, 2021
(86) PCT No.: PCT/US2021/023207

§ 371 Date: Sep. 9, 2022

Related U.S. Application Data
(60) Provisional application No. 63/000,123, filed on Mar. 26, 2020.

(51) Int. Cl. G06Q 20/40; G06Q 20/18; G06Q 20/20; G07G 3/00; G06V 10/74; G06V 20/52; G06V 10/82

(52) U.S. Cl. CPC G06Q 20/4016; G06Q 20/18; G06Q 20/208; G06V 10/82; G06V 10/761; G06V 20/52; G07G 3/003

(57) ABSTRACT

Methods and systems for detecting fraudulent activity at a self-checkout terminals of a retail store include a scanner for scanning an identifier of a candidate product located in the product-scanning area of the self-checkout terminal, and one or more sensors that detect at least one physical characteristic of the candidate product located in the product-scanning area of the self-checkout terminal. A computing device then correlates the obtained electronic data corresponding to actual identifying characteristic information associated with the candidate product to the reference physical characteristic information associated with the reference product in order to generate a similarity score between the actual and reference physical characteristic information. If the similarity score is above a predetermined similarity threshold, the self-checkout terminal is permitted to process a purchase of the candidate product, but if the similarity score is below the threshold, the self-checkout terminal is restricted from processing the purchase.

### CROSS-REFERENCE TO RELATED APPLICATIONS

This application claims the benefit of U.S. Provisional Pat. Application No. 63/000,123, filed Mar. 26, 2020, which is incorporated herein by reference in its entirety.

### TECHNICAL FIELD

This invention relates generally to detecting fraudulent activity at self-checkout terminals of retail stores, and in particular, to systems and methods for detecting “ticket switching,” a fraudulent practice of scanning a barcode of a cheaper product when attempting to actually purchase a more expensive product at a self-checkout terminal.

### BACKGROUND

Retailers lose millions, if not billions, of dollars annually due to fraudulent activities at their self-checkout terminals. One such fraudulent scanning practice, which involves scanning a barcode of a cheaper item when actually attempting to check out a more expensive item at the self-checkout terminal, is called ticket-switching. As a result of ticket-switching, since the item is placed in the product-scanning area of the self-checkout terminal such that the bar code of a less expensive item (not the actual barcode of the more expensive item) is scanned instead, the person engaged in the fraudulent activity is able to buy a more expensive item (e.g., a video game, electronic device, home improvement tool, etc.) at a cheaper price than the actual price for this item. Given that large retailers have millions of products passing through their self-checkout terminals daily, ticket switching results in significant profit losses for retailers, and it would be desirable for retailers to curb the occurrence of ticket-switching to a minimum.

### BRIEF DESCRIPTION OF THE DRAWINGS

Disclosed herein are embodiments of systems and methods of detecting fraudulent activity at a self-checkout terminal of a retail store. This description includes drawings, wherein:

FIG. 1 is a diagram of a system of detecting fraudulent activity at a self-checkout terminal of a retail store in accordance with some embodiments;

FIG. 2 is a functional diagram of an exemplary computing device usable with the system of FIG. 1 in accordance with some embodiments.

FIG. 3 is a flow chart diagram of a process of detecting fraudulent activity at a self-checkout terminal of a retail store in accordance with some embodiments.

FIG. 4 is a flow chart diagram depicting logic flow relating to auto-enrollment and scan verification in connection with the process of detecting fraudulent activity at a self-checkout terminal of a retail store in accordance with some embodiments.

FIG. 5 is a flow chart diagram depicting logic flow relating to optimizing reference model data in connection with the process of detecting fraudulent activity at a self-checkout terminal of a retail store in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, methods and systems for detecting fraudulent activity at self-checkout terminals of a retail store include a scanner for scanning an identifier of a candidate product located in the product-scanning area of the self-checkout terminal and one or more sensors that detect one or more physical characteristics of the candidate product located in the product-scanning area of the self-checkout terminal. A computing device then correlates the obtained electronic data corresponding to actual identifying characteristic information associated with the candidate product to the reference physical characteristic information associated with the reference product in order to generate a similarity score between the actual and reference physical characteristic information. If the similarity score is above a predetermined similarity threshold, the self-checkout terminal is permitted to process a purchase of the candidate product, but if the similarity score is below the predetermined similarity threshold, the self-checkout terminal is restricted from processing the purchase.

In some embodiments, a system for detecting fraudulent activity at a self-checkout terminal of a retail store includes a scanner located proximate a product-scanning area of the self-checkout terminal and configured to scan an identifier of a candidate product located in the product-scanning area of the self-checkout terminal, as well as at least a first sensor located proximate the product-scanning area of the self-checkout terminal and configured to detect at least one physical characteristic of the candidate product located in the product-scanning area of the self-checkout terminal. The system further includes an electronic database configured to store at least one of: electronic data corresponding to the identifier of the candidate product; and electronic data corresponding to reference physical characteristic information associated with a reference model of the candidate product, the reference physical characteristic information associated with at least one image of a reference product, identical to the candidate product, captured by the at least one sensor during a scan of the reference product by the scanner. The system further includes a processor-based computing device in communication with the at least one sensor and the electronic database, with the computing device being configured to: obtain electronic data corresponding to actual identifying characteristic information associated with a candidate product, the actual identifying characteristic information associated with at least one image of the candidate product captured by the at least one sensor at a time of a scan of the candidate product by the scanner; correlate the electronic data corresponding to the actual identifying characteristic information associated with the candidate product obtained by the at least one sensor during the scan of the candidate product by the scanner to the electronic data corresponding to the reference physical characteristic information associated with the reference product in order to generate a similarity score between the actual identifying characteristic information and the reference physical characteristic information; determine if a correlation of the actual identifying characteristic information associated with the candidate product to the reference physical characteristic information associated with the reference product indicates whether the similarity score between the actual identifying characteristic information associated with the candidate product and the reference physical characteristic information associated with the reference product is above or below a predetermined similarity threshold. If the similarity score is above the predetermined similarity threshold, the computing device permits the self-checkout terminal to process a purchase of the candidate product. If similarity score is below the predetermined similarity threshold, the computing device restricts the self-checkout terminal from processing the purchase of the candidate product.

In some embodiments, a method of detecting fraudulent activity at a self-checkout terminal of a retail store includes: scanning, via a scanner located proximate a product-scanning area of the self-checkout terminal, an identifier of a candidate product located in the product-scanning area of the self-checkout terminal; detecting, via a first sensor located proximate the product-scanning area of the self-checkout terminal, at least one physical characteristic of the candidate product located in the product-scanning area of the self-checkout terminal; providing an electronic database configured to store at least one of: electronic data corresponding to the identifier of the candidate product; and electronic data corresponding to reference physical characteristic information associated with a reference model of the candidate product, the reference physical characteristic information associated with at least one image of a reference product, identical to the candidate product, captured by the at least one sensor during a scan of the reference product by the scanner; and providing a processor-based computing device in communication with the at least one sensor and the electronic database; obtaining, by the computing device, electronic data corresponding to actual identifying characteristic information associated with a candidate product, the actual identifying characteristic information associated with at least one image of the candidate product captured by the at least one sensor at a time of a scan of the candidate product by the scanner; correlating, by the computing device, the electronic data corresponding to the actual identifying characteristic information associated with the candidate product obtained by the at least one sensor during the scan of the candidate product by the scanner to the electronic data corresponding to the reference physical characteristic information associated with the reference product in order to generate a similarity score between the actual identifying characteristic information and the reference physical characteristic information; determining, via the computing device, if a correlation of the actual identifying characteristic information associated with the candidate product to the reference physical characteristic information associated with the reference product indicates whether the similarity score between the actual identifying characteristic information associated with the candidate product and the reference physical characteristic information associated with the reference product is above or below a predetermined similarity threshold; permitting the self-checkout terminal to process a purchase of the candidate product in response to a determination by the computing device that the similarity score is above the predetermined similarity threshold; and restricting the self-checkout terminal from processing the purchase of the candidate product in response to a determination by the computing device that the similarity score is below the predetermined similarity threshold.

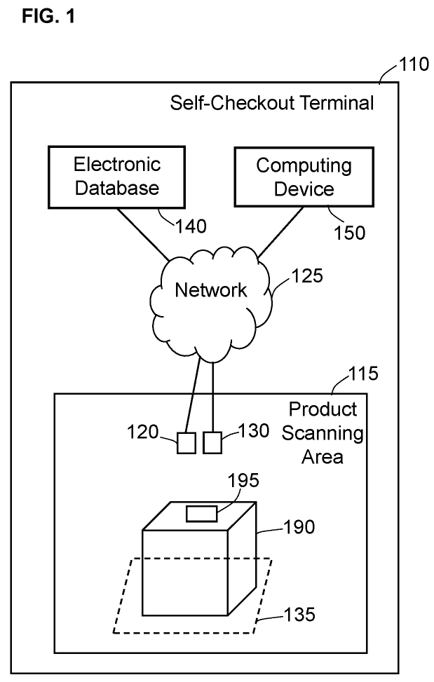

FIG. 1 shows an embodiment of a system 100 of detecting fraudulent activity at a self-checkout terminal 110 of a retail store. The system 100 is shown in FIG. 1 for simplicity of illustration with only one self-checkout terminal 110, but it will be appreciated that the system 100 may include more (e.g., 2-10, or more) self-checkout terminals 110, depending on the size of the retail store, where the self-checkout terminal 110 is installed. By the same token, while the self-checkout terminal 110 is illustrated in FIG. 1 as having one product 190 in the product-scanning area 115 being scanned by a scanner 120, it will be appreciated that the self-checkout terminal 110 may be configured to simultaneously or concurrently scan multiple products 190. In addition, while this application refers to a product 190, it will be appreciated that the self-checkout terminal 110 may be used to scan and process candidate products 190 that are retained in packages, boxes, or the like, and/or loose products that are not packaged. Further, the size of the product 190 in FIG. 1 has been shown by way of example only, and it will be appreciated that the self-checkout terminal 110 may scan and process many different products 190 of different sizes and shapes.

In some embodiments, the self-checkout terminal 110 is configured to require a customer to physically grasp the product 190 and bring the product 190 into the product-scanning area 115 of the self-checkout terminal 110 to permit the scanner 120 to scan the product 190 in order to obtain identifying information associated with the product 190. In other embodiments, the self-checkout terminal 110 is configured to include a conveyor belt-like product advancement surface that moves the 190 in proximity to the scanner 120, such that the scanner 120 is permitted to scan the product 190 in order to obtain identifying information associated with the product 190.

The scanner 120 of the exemplary system 100 depicted in FIG. 1 is configured to detect at least one identifying characteristic of a product 190 located in the product-scanning area 115 of the self-checkout terminal 110. According to some embodiments, the scanner 120 can include one or more sensors including but not limited to a motion-detecting sensor, a photo sensor, a radio frequency identification (RFID) sensor, an optical sensor, a barcode sensor, a digital camera sensor, or the like. In some embodiments, the scanner 120 is configured to scan identifying indicia (e.g., label) 195 located on the product 190 or on the packaging containing the candidate product 190. The identifying indicia 195 on the product 190 that may be scanned by the scanner 120 may include, but is not limited to: two-dimensional barcode, RFID, near field communication (NFC) identifiers, ultra-wideband (UWB) identifiers, Bluetooth identifiers, images, or other such optically readable, radio frequency detectable or other such code, or combination of such codes.

In the embodiment shown in FIG. 1, the system 100 also includes a first sensor 130 positioned proximate the product-scanning area 115 of the self-checkout terminal 110 to permit the sensor 130 to detect at least one physical characteristic of the product 190 (also referred to herein as the “candidate product”) in order to obtain identifying information associated with the candidate product 190. While FIG. 1 depicts the self-checkout terminal 110 of the system 100 as including only one sensor 130, it will be appreciated that the self-checkout terminal 110 terminal may be equipped with more than one sensor 130, and can include, for example sensors including but not limited to: a camera sensor, a photo sensor, an optical sensor, a depth sensor, an ultrasonic sensor, a capacitance sensor, a weight sensor, a volumetric sensor, a size sensor, a 3-D sensor, an infrared sensor, a thermal sensor, a motion-detecting sensor, or the like.

In some aspects, the first sensor 130 that detects at least one physical characteristic of the candidate product 190 located in the product-scanning area 115 of the self-checkout terminal 110 is in the form of a camera that provides for at least one of: image analysis of the product 190 (e.g., size, shape, and color of one or more sides of the product), text recognition on the candidate product 190 (e.g., product name), and/or pattern recognition on the product 190 (e.g., color pattern or barcode pattern). In certain aspects, the sensor 130 is a “top-down” camera positioned such that it is located above the candidate product 190 being scanned by the scanner 120 in the product-scanning area 115. In one aspect, the camera sensor 130 generates video image data that includes a timestamp attached to each frame.

In some embodiments, as will be described in more detail below, the physical characteristic information of a candidate product 190 detected by the sensor 130 is transmitted by the sensor 130 and later correlated by the computing device 150 to the reference physical characteristics associated with the candidate product 190 (which information may be obtained by the computing device 150 from the electronic database 170). In certain aspects, if this correlation comparison of the actual physical characteristics of the candidate product 190 that is captured by the sensor 130 to the reference physical characteristics associated in the electronic database 140 with the reference product 190 indicates a discrepancy that exceeds a certain tolerated threshold between the candidate product 190 and the reference product data (e.g., a pre-defined difference between the similarly scores of the candidate product 190 and the reference product data), an alert (which may be indicative of ticket-switching) is triggered, and the self-checkout terminal 110 becomes restricted from processing the purchase of the candidate product 190.

In certain implementations, the camera-based sensor 130 is configured to capture an image of the candidate product 190 located in the product-scanning area 115 of the self-checkout terminal 110, and to compress the captured image prior to transmitting the compressed image to another electronic device (e.g., electronic database 140, computing device 150, etc., which will be discussed in more detail below). This image compression by the camera-based sensor 130 advantageously reduces the storage requirements of the electronic database 140 (as compared to capturing and transmitting full-size images), and advantageously reduces the processing power required of the computing device 150 to process the compressed image (as compared to the full-size image) when attempting to detect any physical characteristic of the candidate product 190 based on processing the image captured by the camera-based sensor 130 and stored in the electronic database 140.

In one aspect, the self-checkout terminal 110 may include a weight sensor 135 in the form of a plate or the like positioned in the product-scanning area 115 of the self-checkout terminal 110 that provides for the measurement of the weight of the product 190 when the product 190 is located in the product-scanning area 115. In some embodiments, as will be described in more detail below, a weight of a candidate product 190 detected by the weight sensor 135 is transmitted by the weight sensor 135 (e.g., to the electronic database 140 or to the computing device 150) and later correlated by the computing device 150 to a reference weight of the product 190 (which predefined weight may be obtained by the computing device 150 from the electronic database 170). In certain aspects, if this correlation comparison, by the computing device 150, of the actual weight of the candidate product 190 that is measured by the weight sensor 135 to the reference weight associated with the candidate product 190 indicates a discrepancy that exceeds a certain tolerated threshold (e.g., a pre-defined difference between the between the two weights), an alert (which may be indicative of ticket-switching) is triggered, and the self-checkout terminal 110 becomes restricted (e.g., in response to an alert signal received from the computing device 150) from processing the purchase of the candidate product 190.

In some aspects, a product physical characteristic-detecting sensor 130 may be an infrared and/or a thermal sensor that measures the temperature of the candidate product 190 and/or insulation integrity of the packaging of the product 190 when the candidate product 190 is located in the product-scanning area 115. In some embodiments, the product physical characteristic-detecting sensor 130 is a 3D scanner or sensor configured to detect and/or measure the shapes and/or dimensions of the candidate product 190 on one or more sides when the candidate product 190 is located in the product-scanning area 115.

It will be appreciated that the physical locations of the scanner 120 and sensor 130 relative to the product-scanning area 115 have been shown by way of example only, and that in some embodiments, the scanner 120 and the sensor 130 (which may be one sensor or an array of various sensors), may be positioned in various locations and orientations relative to the product-scanning area 115. It will also be appreciated that one or more of the sensors 130 and 135 can be physically incorporated (e.g., coupled to, embedded, etc.) into the physical structure of the self-checkout terminal 110 and/or the computing device 150, or may be stand-alone sensors.

In the embodiment shown in FIG. 1, the system 100 includes an electronic database 140. In some embodiments, the electronic database 140 and the computing device 150 (which will be discussed below) may be implemented as two separate physical devices in the same physical location as the self-checkout terminal 110 of system 100 as shown in FIG. 1. It will be appreciated, however, that the computing device 150 and the electronic database 140: (1) may be implemented as a single physical device; (2) may be incorporated into the physical structure of the self-checkout terminal 110; and/or (3) may be located at different locations relative to each other and relative to the self-checkout terminal 110.

In some embodiments, the electronic database 140 may be stored, for example, on non-volatile storage media (e.g., a hard drive, flash drive, or removable optical disk) internal or external to the computing device 150 and/or the self-checkout terminal 110, or internal or external to computing devices distinct from the computing device 150 and the self-checkout terminal 110. In some embodiments, the electronic database 140 may be cloud-based.

In some embodiments, the exemplary electronic database 140 of FIG. 1 is configured to store electronic data associated with the product 190 that are stocked and sold at the retail store. Some exemplary electronic data that may be stored in the electronic database 140 includes but is not limited to: (1) electronic data corresponding to identifiers of candidate products 190 (e.g., electronic data associated with the information captured by the scanner 120 from the identifying indicia 195 (e.g., a label) of a candidate product 190 when the candidate product 190 is scanned by the scanner 120 in the product-scanning area 115 of the self-checkout terminal 110); (2) electronic data corresponding to reference physical characteristic information associated with a reference model associated with the candidate products 190; (3) electronic data corresponding to actual identifying characteristics of the candidate products 190 captured by the sensor 130, sensor 135, etc.; (4) electronic data representative of pre-defined similarity thresholds, which are analyzed by the computing device 150 (as will be discussed in more detail below) in order to determine whether to generate or to not generate an alert that restricts the self-checkout terminal 110 from processing a purchase of the candidate product 190 by the customer; (5) electronic data indicating all alerts historically generated at the self-checkout terminal 110 in association with any of the candidate products 190 processed by the self-checkout terminal 110; and (6) electronic data indicating all purchases successfully processed by the self-checkout terminal 110. Generally, the reference physical characteristic information is electronic data associated with at least one image of a reference product 190 (identical to the candidate product 190) that is captured by one or more sensors 130, 135, etc. during an earlier scan of the reference product 190 by the scanner 120 when the reference product 190 was processed for purchase at the self-checkout terminal 110.

The exemplary system 100 of FIG. 1 further includes a computing device 150 configured to communicate with the electronic database 140 and the self-checkout terminal 110, the scanner 120, the sensor 130, and/or the sensor 135 over the network 125. The exemplary network 125 depicted in FIG. 1 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 100 may take place over hard-wired, wireless, cellular, Wi-Fi or Bluetooth networked components or the like. In some embodiments, one or more electronic devices of system 100 may include cloud-based features, such as cloud-based memory storage.

The computing device 150 may be a stationary or portable electronic device, for example, a desktop computer, a laptop computer, a tablet, a mobile phone, or any other electronic device including a processor-based control circuit (i.e., control unit). In the embodiment of FIG. 1, the computing device 150 is configured for data entry and processing as well as for communication with other devices of system 100 via the network 125. As mentioned above, the computing device 150 may be located at the same physical location as (or physical incorporated into one physical structure with) the self-checkout terminal 110 and/or the electronic database 140, or may be located at a remote physical location relative to the self-checkout terminal 110 and/or the electronic database 140.

In some embodiments, the system 100 includes one or more localized Internet-of-Things (IoT) devices and controllers in communication with the computing device 150. As a result, in some embodiments, the localized IoT devices and controllers can perform most, if not all, of the computational load and associated monitoring that would otherwise be performed by the computing device 150, and then later asynchronous uploading of summary data can be performed by a designated one of the IoT devices to the computing device 150, or a server remote to the computing device 150. In this manner, the computational effort of the overall system 100 may be reduced significantly. For example, whenever a localized monitoring allows remote transmission, secondary utilization of controllers keeps securing data for other IoT devices and permits periodic asynchronous uploading of the summary data to the computing device 150 or a server remote to the computing device 150.

In addition, the periodic asynchronous uploading of summary data may include a key kernel index summary of the data as created under nominal conditions. In an exemplary embodiment, the kernel encodes relatively recently acquired intermittent data (“KRI”). As a result, in some embodiments, KRI includes a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in some embodiments, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In some aspects, KRG incrementally sequences all future undefined cached kernels of data in order to filter out data that may reflect generic background data. In other aspects, KRG incrementally sequences all future undefined cached kernels having encoded asynchronous data in order to filter out data that may reflect generic background data.

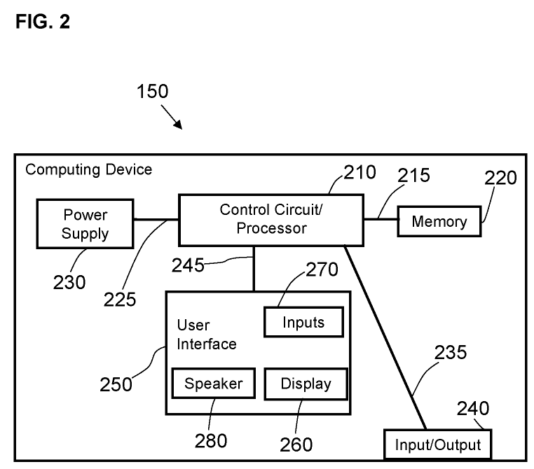

With reference to FIG. 2, the computing device 150 associated with the self-checkout terminal 110 (e. g., operatively coupled to the self-checkout terminal 110 or incorporated into the physical structure of the self-checkout terminal 110) and configured for use with exemplary systems and methods described herein may include a control unit or control circuit 210 including a processor (e.g., a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 210 can be configured (for example, by using corresponding programming stored in the memory 220 as will be well understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

The control circuit 210 of the computing device 150 is also electrically coupled via a connection 235 to an input/output 240 that can receive signals from, for example, from the scanner 120, the sensors 130, 135, etc., the electronic database 170, and/or from another electronic device (e.g., a hand-held electronic device of a worker tasked with monitoring the self-checkout terminal 110) over the network 125. The input/output 240 of the computing device 150 can also send signals to the self-checkout terminal 110, for example, an alert signal that halts operation of the self-checkout terminal 110 and restricts the self-checkout terminal 110 from processing the purchase of the candidate product 190 until, for example, input from a worker tasked with watching the self-checkout terminal 110 indicates that the candidate product 190 has been verified.

The processor-based control circuit 210 of the computing device 150 shown in FIG. 2 is electrically coupled via a connection 245 to a user interface 250, which may include a visual display or display screen 260 (e.g., LED screen) and/or button input 270 that provide the user interface 250 with the ability to permit an operator (e.g., worker at a the retail facility (or a worker at a remote control center) tasked with monitoring the operation of the self-checkout terminal 110) of the computing device 150 to manually control the computing device 150 by inputting commands via touch-screen and/or button operation and/or voice commands. Possible commands may, for example, cause the computing device 150 to cause transmission of an alert signal to an electronic device of a worker at the retail store to notify the worker that the self-checkout terminal 110 has been suspended, and requires the worker to visually confirm that the candidate product 190 is not being subjected to a fraudulent checkout method such as ticket-switching.

For example, such manual control by an operator may be via the user interface 250 of the computing device 150, via another electronic device of the operator, or via another user interface and/or switch, and may include an option to override the alert initially generated by the computing device 150 upon a visual inspection of the self-checkout terminal 110 and the candidate product 190 by the worker, and the worker’s confirmation that no fraudulent activity has occurred with respect to the checkout of the candidate product 190 at the self-checkout terminal 110. In some embodiments, the user interface 250 of the computing device 150 may also include a speaker 280 that provides audible feedback (e.g., alerts) to the worker. It will be appreciated that the performance of such functions by the processor-based control circuit 210 of the computing device 150 is not dependent on a human operator, and that the control circuit 210 may be programmed to perform such functions without a human operator.

In some embodiments, the control circuit 210 of the computing device 150 is configured obtain the above-referenced electronic data from the electronic database 140, and to process such data in order to make a determination regarding the likelihood that the customer attempting to purchase the candidate product 190 via the self-checkout terminal 110 is engaging in fraudulent activity (e.g., ticket-switching). In some aspects, for example, the control circuit 210 of the computing device 150 is programmed to obtain electronic data corresponding to actual identifying characteristic information associated with a candidate product 190. As mentioned above, in certain embodiments, the actual identifying characteristic information represents electronic data associated with and/or based upon at least one image of the candidate product 190 that is captured by one or more sensors (e.g., the sensor 130) at a time of a scan by the scanner 120 of the candidate product 190 located in the product-scanning area 115.

In some embodiments, after obtaining (e.g., from the electronic database 140 or directly from the sensor(s) 130) the actual identifying characteristic information associated with the candidate product 190 being scanned by the scanner 120 in the product-scanning area 115 and obtaining (e.g., from the electronic database 140) the electronic data corresponding to the reference physical characteristic information associated with the reference product 190, the control circuit 210 of the computing device 150 is programmed to correlate the electronic data corresponding to the actual identifying characteristic information associated with the candidate product 190 to the electronic data corresponding to the reference physical characteristic information associated with the reference product 190 in order to generate a similarity score between the actual identifying characteristic information and the reference physical characteristic information. Generally, a correlation of the actual physical characteristic information associated with the candidate product 190 to the reference physical characteristic information associated with the reference product 190 requires the presence of corresponding reference physical characteristic information in the electronic database 140 (i.e., requires that a product identical to the candidate product 190 has previously been processed at the self-checkout terminal 110, and that a reference model has been generated and recorded in the electronic database 140 in association with that reference scan).

In some situations, the candidate product 190 may be a product that is being processed at the self-checkout terminal 110 for the first time, and the electronic database 140 may not yet have electronic data representing the reference model data indicative of the reference physical characteristics for the candidate product 190. Accordingly, in some aspects, the control circuit 210 of the computing device 150 is programmed to automatically generate a reference physical characteristics model for a first time-scan candidate product 190, and to update the electronic database 140 to include electronic data representing a reference model associated with this candidate product 190 (i.e., auto-enrollment) into the electronic database 140.

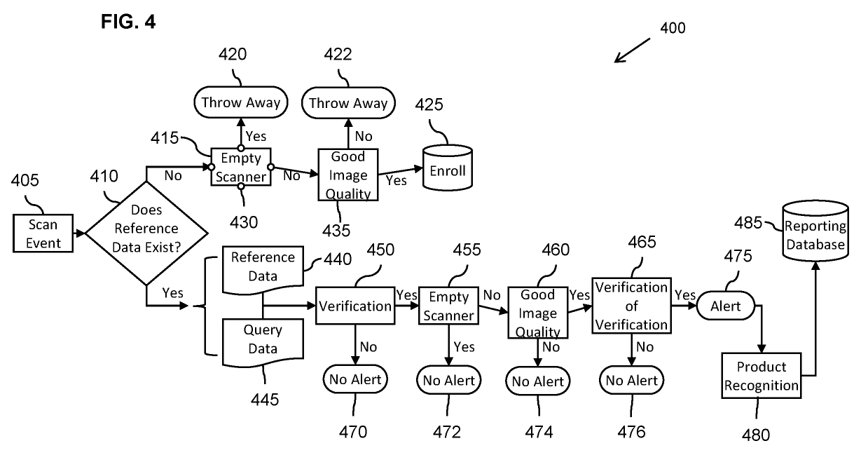

To that end, in one embodiment, in response to a determination by the computing device 150 that the electronic database 140 does not include a reference model for the candidate product 190, the computing device is configured to initiate a conversion of the electronic data (e.g., one or more digital images captured by a camera sensor 130) corresponding to the actual identifying characteristic information associated with a candidate product 190 into electronic data (e.g., a set of numerical values representing one or more fixed size vectors) corresponding to the reference model for the candidate product 190 for use in subsequent scans of other identical candidate products 190. In one implementation, after this conversion is complete, the computing device 150 transmits the electronic data corresponding to the generated reference model for the candidate product 190 to the electronic database 140 for storage. An exemplary logic flow relating to auto-enrollment is depicted in FIG. 4.

With reference to FIG. 4, the logic flow 400 starts with a scan event (step 405), where the candidate product 190 is scanned by the scanner 120 and sensor 130 in the product-scanning area 115 of the self-checkout terminal 110. In response to receiving identifying data from scanner 120 and/or physical characteristics data from sensor 130 for a candidate product 190 scanned by the scanner 120, the computing device 150 queries the electronic database 140 to determine whether reference data exists in the electronic database 140 for the candidate product 190 (step 410). According to some implementations, if no reference data exists, the computing device 150 is programmed to obtain sensor data (e.g., from sensor 130) to determine whether the product-scanning area 115 is empty or not (step 415). If the product-scanning area 115 is empty, the computing device 150 would discard the received identifying data (step 420). If, on the other hand, the product-scanning area 115 is not empty, the computing device 150 is programmed to determine whether the image quality associated with the scanned candidate product 190 is of sufficient quality to make a high confidence determination regarding the candidate product 190 (step 435). If the received image is determined to be not of good quality, then the computing device 150 would discard the received identification data (step 422), but if the received image is determined to be of good quality, then the computing device 150 would enroll the candidate product 190 by generating data that is transmitted to the electronic database 140 for storage in association with the candidate product 190 (step 425).

In certain aspects, the electronic data corresponding to the reference physical characteristic information associated with the reference model of each candidate product 190 is stored in the electronic database 140 in a form of a set of numerical values representing one or more fixed size vectors (e.g., 512-dim) associated with the reference product 190. In one aspect, the one or more fixed size vectors stored in the electronic database 140 as a reference model for a given product 190 represent an output of an encoding, via a neural network (e.g., a Visual Geometry Group (VGG) deep convolutional neural network, a Residual Neural Network (Resnet), Inception Neural Network, or the like), of one or more images of a reference product (acquired by a sensor 130) into the fixed size vectors associated with the reference product.

When a candidate product 190 is scanned by the scanner 120 and at least one image of the candidate product 190 is captured by the sensor 130, the electronic data representative of the image(s) may be transmitted by the sensor 130 over the network 125 to the electronic database 140 to be obtained by the computing device 150, or directly to the computing device 150. In one aspect, after the electronic data corresponding to actual identifying characteristic information associated with a candidate product 190 (e.g., digital image data captured by the sensor 130) is obtained by the computing device 150, the control circuit 210 of the computing device 150 is programmed to encode the image(s) of the candidate product 190 captured by the sensor(s) 130 at a time of a scan of the candidate product 190 by the scanner 120 into a set of numerical values representing at least one fixed size vector associated with the candidate product 190. After this encoding of image data into fixed size vector values is complete, the control circuit 210 of the computing device 150 is programmed to correlate aggregate average numerical values representing the fixed size vectors associated with the reference product 190 to the aggregate average numerical values representing the fixed size vectors associated with the candidate product 190. This correlation enables the control circuit 210 of the computing device 150 to determine (i.e., calculate) a similarity score indicative of how similar or dissimilar the numerical values representing the fixed size vectors associated with the candidate product 190 are to the numerical values representing the fixed size vectors associated with the reference product 190.

In some embodiments, the computing device 150 is programmed to monitor checkout events (e.g., a scan of an RFID or barcode 195 of the candidate product 190 by the scanner 120) that occur at the self-checkout terminal 110, while at the same time analyzing the video frames received from a camera sensor 130. An exemplary checkout event may be represented by electronic data including the unique identifier of the candidate product 190, as well as a timestamp of when the candidate product 190 was scanned. In one aspect, after a check-out event is received, the control circuit 210 of the computing device 150 is programmed to seek the video frames from a smaller time window (usually 1-2 seconds), which covers the detected check-out event, then analyze the video frames in an attempt to detect whether the candidate product 190 associated with the identifier detected by the scanner 120 during the attempted checkout event is actually present or not present in the product-scanning area 115 of the self-checkout terminal 110.

In some aspects, the control circuit 210 is programmed to, based on the correlation of the actual identifying characteristic information associated with the candidate product 190 to the reference physical characteristic information associated with the reference product 190, the control circuit 210 of the computing device 150 is programmed to cause the computing device 150 to transmit a signal to the electronic database 140 in order to update the electronic database 140 by replacing the reference physical characteristic information associated with the reference product 190 stored in the electronic database 140 with the actual identifying characteristic information associated with the candidate product 190. As described in more detail below, this update of the electronic database 140 generally occurs when the control circuit 210 of the computing device 150 determines that the actual identifying characteristic information associated with the candidate product 190 has a similarity score that warrants replacement of the reference physical characteristic information associated with the candidate product 190 with the actual identifying characteristic information associated with the candidate product 190, such that the actual identifying characteristic information for the candidate product 190 becomes the new reference model.

In various implementations, the control circuit 210 of the computing device 150 is programmed to continuously build and update the reference model data set associated with the products 190 being processed at the self-checkout terminal 110. As mentioned above, when a candidate product 190 comes through the self-checkout terminal 110 for the first time, the computing device 150 generates a reference model data set in association with the candidate product 190, and transmits this reference model data set to the electronic database 140 for storage and future retrieval (this process is referred to above as “enrollment”). In some aspects, as the computing device 150 continuously acquires additional electronic data representative of the scans of additional candidate products 190, the control circuit 210 of the computing device is programmed to process the obtained image data as discussed above, and to score the incoming data in order to determine whether the reference model data associated with a given scanned candidate product 190 should be preserved, or replaced with the newly received image data based on the current scan of the candidate product 190.

Generally, the control circuit 210 of the computing device 150 is programmed to process the reference product image-associated data and the candidate product image-associated data to output (using an encoding network) candidate fixed size vector data and reference fixed size vector data. In some embodiments, as discussed in more detail below, this candidate and reference vector data is then processed via a scoring neural network to generate a quality score for the images (which is then normalized to achieve a final similarity score), as well as via a verification neural network to generate a similarity score (which is then weighted and averaged to achieve the final similarity score).

For example, in certain aspects, the control circuit 210 of the computing device 150 is programmed to analyze, via a scoring neural network, the fixed size vector(s) associated with the candidate product 190, and to generate an image quality score indicative of an overall quality of the image(s) of the candidate product captured by the sensor(s) 130 at the time of the scan of the candidate product 190 by the scanner 120. In some aspects, the fixed size vector representation (e.g., 512-dim) captures the high-level visual features of the input image of the candidate product 190 that was captured by the sensor 130 during the scanning of the candidate product by the scanner 120, and the scoring neural network takes the vector representation and outputs a quality score from 0 to 1, indicating how informative the corresponding image is, with values close to 1 being considered highly informative, and values close to 0 being considered less informative.

For example, if the sensor 130 captures an image of the candidate product 190, where the product is occluded by an interfering object positioned between the sensor 130 and the candidate product 190, such an image is likely to get a quality score of close to 0, since it is hard to see the actual product from the image. When, based on this analysis, the control circuit 210 determines that the image quality score is above a predetermined image quality threshold, the control circuit 210 of the computing device 150 is programmed to correlate the aggregate average numerical values representing the fixed size vector(s) associated with the reference product to the aggregate average numerical values representing the fixed size vector(s) associated with the candidate product 190 in order to determine the similarity score.

In certain implementations, the computing device 150 is implemented to include a verification neural network, which takes a pair of vectors representing (1) an image (also referred to herein as a “query image”) of a candidate product 190 captured from the current scan of the candidate product 190 by the scanner 120 and sensor 130, and (2) a reference image associated with the candidate product 190 in the electronic database 140, and outputs a similarity score from 0 to 1, indicating how similar the pair of images are (with values close to 0 being less similar and values close to 1 being highly similar). For detection, the computing device 150 can be configured to take: (1) several (e.g., 1, 2, 3, or more) query images of the candidate product 190 captured by the sensor 130 when the candidate product 190 is located in the product-scanning area 115 within a time window of when a scan of the candidate product 190 by the scanner 120 is detected; and (2) several (e.g., 1, 2, 3, or more) reference images (also referred to herein as an “enrollment set”) stored in the electronic database 140 in association with the candidate product 190, and compute similarity scores for all of the possible pairs of the query images and the reference images, then average the computed similarity scores using the image quality scores as weights (e.g., by filtering out the contribution from lower-scoring, less informative images).

In some implementations, the control circuit 210 of the computing device 150 calculates and outputs a similarity score for every query-reference pair in a scan. That is, in some implementations, if there are 6 query images and 10 reference images, there are 60 pairs that each produce a confidence score (and every additional sensor would output a score for each of the query-reference data pairs). This analysis, which takes into account and analyzes several outputs from the scan-instance verification model, enables the control circuit 210 of the computing device 150 to make an aggregate decision at the scan level, not at the individual sensor-output level, with the aggregate decision providing a higher confidence in the determination of the similarity between the query images of the candidate product 190 captured by the sensor(s) 130 and the reference model images stored in the electronic database 140.

In certain aspects, if the aggregated score (ranging from 0 to 1), i.e., the normalized perceived distance (referred to herein as “NPD”), is more than (i.e., above) a fixed threshold, the system will trigger an alert for the self-checkout terminal 110. Thus, in some aspects, the control circuit 210 of the computing device 150 determines if a correlation of the actual identifying characteristic information associated with the candidate product 190 to the reference physical characteristic information associated with the reference product indicates whether the aggregated similarity score between the actual identifying characteristic information associated with the candidate product 190 and the reference physical characteristic information associated with the reference product is above or below the predetermined similarity threshold, and then: (1) if the similarity score is above the predetermined similarity threshold, the control circuit 210 of the computing device 150 is programmed to permit the self-checkout terminal 110 to process a purchase of the candidate product 190; and (2) if the similarity score is below the predetermined similarity threshold, the control circuit 210 of the computing device 150 is programmed to restrict the self-checkout terminal 110 from processing the purchase of the candidate product 190.

In particular, in some aspects, the control circuit 210 of the computing device 150 is programmed to compare the data generated in response to receipt of new scan data for a new candidate product 190 with the existing reference model set stored in the electronic database, and to take the candidate product 190 with the lowest average similarity score (compared to the reference model data set), and then compare it to the reference data point with the highest average similarity score (compared to others in reference model set), and to remove that reference data set having the highest average similarity score from the electronic database 140 and to replace this reference data set with the candidate data associated with the lowest average similarity score.

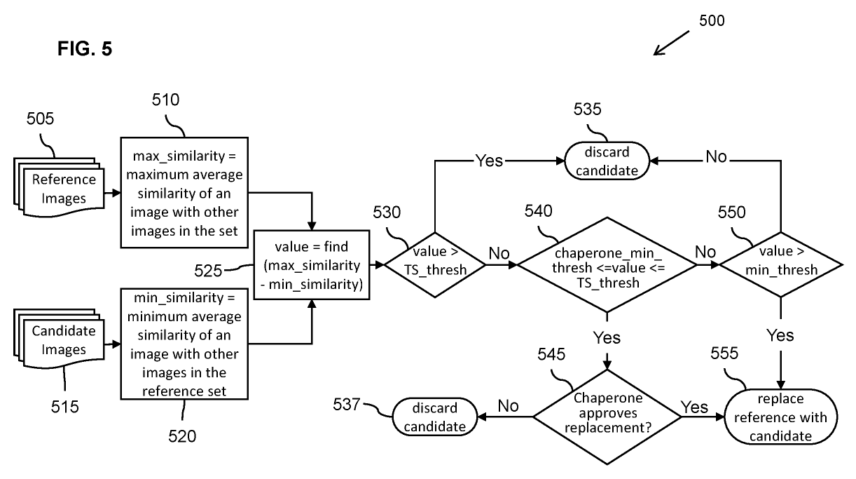

In some embodiments, the auto-updating of the reference model data stored in the electronic database 140 in association with the candidate products 190 is described below in more detail with reference to the logic flow 500 of FIG. 5. First, as the candidate products 190 are scanned by the scanner 120 and sensor 130 of the self-checkout terminal 110, the control circuit 210 of the computing device 150 processes the image data as described above to output the normalized perceived distance and an embedding vector for each of the processed scan images. For the candidate product images 515, the control circuit 210 is programmed to calculate a minimum similarity threshold (Threshₘᵢₙ) as being equal to the minimum average similarity of a candidate image with other images in the reference set associated with a product identical to the candidate product (step 520). For the reference product images 505, the control circuit 210 is programmed to calculate a maximum similarity (Threshₘₐₓ) as being equal to a maximum average similarity of an image with other images in the set (step 510). After calculating Threshₘᵢₙ and Threshₘₐₓ, the control circuit 210 is programmed to calculate the difference between Threshₘₐₓ and Threshₘᵢₙ (referred to herein as the “difference value”) (step 525). In some aspects, the control circuit 210 is programmed, based on this difference value, to perform several functions when analyzing the query images and reference images to detect possible ticket-switching.

With reference to FIG. 5, if the control circuit 210 determines that the difference value is greater than the ticket-switching threshold value TSₜₕᵣₑₛₕ (step 530), then the control circuit 210 is programmed to: (1) interpret this correlation as an indication of ticket-switching; (2) not update the reference model for the candidate product 190 in the electronic database 140; and (3) discard the query data associated with the candidate product 190 (step 535). If the difference value is less than the ticket-switching threshold value TSₜₕᵣₑₛₕ, then the control circuit 210 is programmed to generate an alert and to require that a worker (also referred to herein as a “chaperone”) tasked with monitoring activity at the self-checkout terminal 110 manually confirm whether the difference value is actually less than TSₜₕᵣₑₛₕ and at the same time greater than Threshₘᵢₙ value (step 540). If the difference value is actually less than TSₜₕᵣₑₛₕ and at the same time greater than Threshₘᵢₙ value, and the chaperone approves a replacement of the reference value in the electronic database 140 with the candidate value (step 545), then the reference value is replaced with the candidate value (step 555). If the difference value is actually less than TSₜₕᵣₑₛₕ and at the same time greater than Threshₘᵢₙ value, but the chaperone does not approve the replacement of the reference value in the electronic database 140 with the candidate value, then the reference value is not replaced with the candidate value and the candidate value is discarded (step 537).

As can be seen in FIG. 5, if, after the verification of the chaperone, it is determined that the difference value is not less than Threshₘᵢₙ value, but is greater than the Threshₘᵢₙ value (step 550), then the control circuit 210 is programmed to: (1) interpret this correlation as an indication that the reference images associated with the scanned candidate product 190 are highly similar to actual images of the candidate product 190; (2) not update the reference model for the candidate product 190 in the electronic database 140; and (3) discard the query data associated with the candidate product 190 (step 535). On the other hand, if the difference value is greater than the Threshₘᵢₙ, then the control circuit 210 is programmed to replace the reference value with the candidate (step 555). In other words, in some aspects, the control circuit 210 of the computing device 150 is programmed to select, from all of the candidate images, the candidate image that is most dissimilar from all the reference images and which will be the best reference image, while at the same time comparing all reference images to each other in order to find the most similar image which will be the worst candidate image. To illustrate this principle, Table 1, reproduced below, represents calculated similarity scores for the newly-acquired images of each candidate product (i.e., C1, C2, CN) relative to the reference images (R1, R2, R3, R4, RN) stored in the electronic database 140 in association with the candidate product 190.

TABLE 1

| | C1 | C2 | CN | R1 | R2 | R3 | R4 | RN |
|---|---|---|---|---|---|---|---|---|
| R1 | 52 | 88 | 94 | - | 96 | 92 | 81 | 94 |
| R2 | 89 | 87 | 95 | 96 | - | 82 | 73 | 99 |
| R3 | 99 | 73 | 93 | 92 | 82 | - | 91 | 93 |
| R4 | 71 | 88 | 91 | 81 | 73 | 91 | - | 91 |
| RN | 83 | 90 | 99 | 94 | 99 | 93 | 91 | - |
| AVG. | 78.80 | 85.20 | 94.40 | 90.75 | 87.50 | 89.50 | 84.00 | 94.25 |

In Table 1 above, the image data acquired for candidate product C1 has the lowest average similarity score (i.e., 78.80) relative to the image data reference values R1, R2, R3, R4, and RN (i.e., 52, 89, 99, 71, and 83) previously recorded in the electronic database for a product identical to C1. By the same token, when the image data reference values are compared to each other (i.e., when the similarity scores of R1, R2, R3, R4, and RN in the vertical column are correlated against the values of R1, R2, R3, R4 and RN in the horizontal row), it is apparent that RN in the vertical row has the highest average similarity score of 94.25. Thus, given the data set of Table 1, the control circuit 210 of the computing device is programmed to replace the reference data RN associated with the highest similarity score 94.25 from the electronic database 140, and to replace this data with the actual image data obtained from candidate product 190 C1, which will now become the new reference data model for this product for purposes of future scans (until a new, better, reference model is found).

In some aspects, as mentioned above, the computing device 150 is programmed such that, in response to a determination, by the computing device 150, that the similarity score is below the predetermined similarity threshold, the computing device 150 transmits an alert signal to an electronic device of a worker at the retail store, prompting a worker tasked with monitoring the self-checkout terminal 110 to inspect the candidate product 190 that the customer is attempting to check out in the product-scanning area 115 of the self-checkout terminal 110 (i.e., to verify whether the label 195 scanned by the scanner 120 is actually the candidate product 190 with which this label 195 is actually associated, or whether there is ticket-switching (or some other error/anomaly) is involved). Exemplary process flow for the determination, by the computing device 150, of whether or not to generate an alert is described below with reference to FIG. 4.

With reference to FIG. 4, after the candidate product 190 is scanned by the scanner 120 and/or sensor 130, and the computing device 150 determines that reference data is stored in the electronic database in association with this candidate product 10 (step 410), the control circuit 210 of the computing device 150 correlates the query data 445 associated with the candidate product 190 to the reference data 440 stored in the electronic database 140. If this correlation (step 450) indicates that ticket-switching is not likely (i.e., if the ticket-switching threshold is exceeded), the control circuit 210 of the computing device 150 is programmed to not generate an alert (step 470). If this correlation indicates that ticket-switching is likely, the control circuit 210 is programmed to determine whether the query data indicates that the product-scanning area 115 is empty or not (step 455).

If the query data indicates that the product-scanning area 115 is empty, then the control circuit 210 is programmed to not generate an alert (step 472). If the query data indicates that the product-scanning area 115 is not empty, the control circuit 210 is programmed to determine whether the query image data is of sufficiently high quality to make a high confidence determination (step 460). If the query image data is determined by the control circuit 210 to not be of good quality, then the control circuit 210 is programmed to not generate an alert (step 474). If the query image data is determined by the control circuit 210 to be of good quality, then the control circuit 210 is programmed to analyze the verification process and to determine whether the initial determination (of whether ticket-switching is likely or not) can be trusted with a high confidence (step 465). If the control circuit 210 determines that the answer is no, then the control circuit 210 is programmed to not generate an alert (step 476). On the other hand, if the answer is yes, then the control circuit 210 is programmed to generate an alert (step 475), and to halt operation of the self-checkout terminal 110 and prompt manual recognition of the candidate product 190 by a chaperone tasked with monitoring the self-checkout terminal (step 480), and to transmit data indicative of this alert to the electronic database 140 for storage (step 485).

In some aspects, as mentioned above, when the alert is generated by the computing device 150, the control circuit 210 of the computing device 150 is programmed to transmit a signal that causes the self-checkout terminal 110 to halt operations relating to the processing of the purchase of the candidate product 190, pending the manual verification of the candidate product 190 by the chaperone. More specifically, in some embodiments, if the chaperone verifies that the scanned label 195 actually corresponds to the candidate product 190 (i.e., no ticket-switching is involved), then the chaperone can enter, via the chaperone’s electronic device, an input indicating that the chaperone validated the identity of the candidate product 190, and the computing device 150 would then transmit a control signal to the self-checkout terminal 110 in order to permit the self-checkout terminal 110 to process the purchase of the candidate product 190 the identity of which has been validated. On the other hand, if the input by the chaperone indicates that the scanned label 195 does not correspond to the candidate product 190 (i.e., ticket-switching may be involved), then the computing device 150 would transmit a control signal to the self-checkout terminal 110 in order to restrict the self-checkout terminal 110 from processing the purchase of the candidate product 190 the identity of which has been validated. It will be appreciated that the chaperone may input verification data directly into the self-checkout terminal 110 in order to either permit the self-checkout terminal 110 to process the purchase of the candidate product 190, or to restrict the self-checkout terminal 110 from processing the purchase of the candidate product 190.

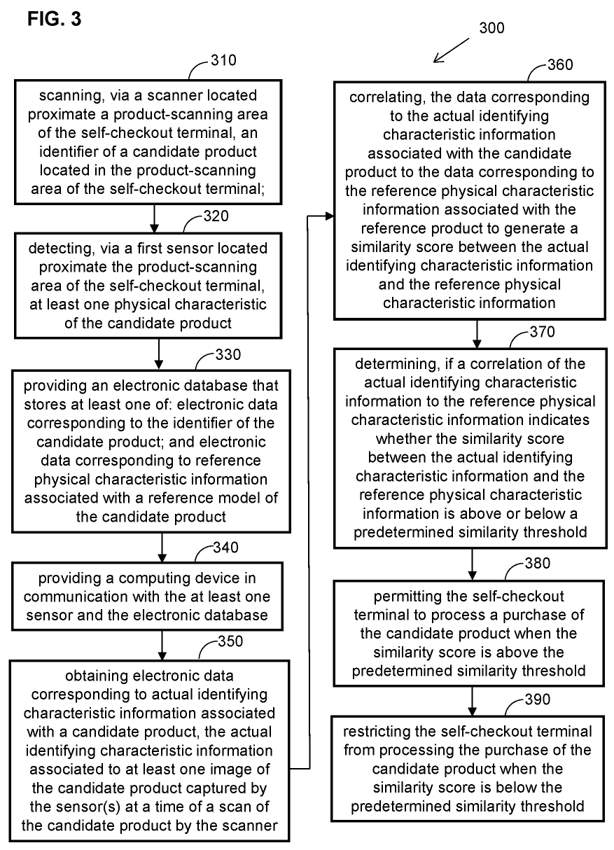

FIG. 3 shows an embodiment of an exemplary method 300 of detecting fraudulent activity at a self-checkout terminal 110 of a retail store. The method 300 includes scanning, via a scanner 120 located proximate a product-scanning area 115 of the self-checkout terminal 110, an identifier 195 of a candidate product 190 located in the product-scanning area 115 of the self-checkout terminal 110 (step 310). As described above, the scanner 120 may include one or more sensors including but not limited to a motion-detecting sensor, a photo sensor, a radio frequency identification (RFID) sensor, an optical sensor, a barcode sensor, a digital camera sensor, or the like. As also mentioned above, the scanning may include the customer physically grasping the candidate product 190 and bringing the candidate product 190 into the product-scanning area 115 of the self-checkout terminal 110 to permit the scanner 120 to scan the product candidate 190 in order to obtain identifying information associated with the candidate product 190.

The method 300 of FIG. 3 further includes detecting, via a first sensor 130 located proximate the product-scanning area 115 of the self-checkout terminal 110, at least one physical characteristic of the candidate product 190 located in the product-scanning area 115 of the self-checkout terminal 110 (step 320). As mentioned above, the sensor 130 may include but is not limited to: a camera sensor, a photo sensor, an optical sensor, a depth sensor, an ultrasonic sensor, a capacitance sensor, a weight sensor, a volumetric sensor, a size sensor, a 3-D sensor, an infrared sensor, a thermal sensor, a motion-detecting sensor, or the like. In some aspects, the first sensor 130 that detects at least one physical characteristic of the candidate product 190 located in the product-scanning area 115 of the self-checkout terminal 110 is in the form of a camera (e.g., a top-down camera) that provides for at least one of: image analysis of the product 190 (e.g., size, shape, and color of one or more sides of the candidate product 190), text recognition on one or more sides of the candidate product 190 (e.g., product name), and/or pattern recognition on one or more sides of the product 190 (e.g., color pattern or barcode pattern).

As discussed above, the electronic data obtained by the scanner 120 and sensors 130 and 135 is transmitted over the network 125 to an electronic database 140 for storage and is available for retrieval from the electronic database 140 by the computing device 150. To that end, the method 300 of FIG. 3 further includes providing an electronic database 140 that is configured to store at least one of: electronic data corresponding to the identifier 195 of the candidate product 190; and electronic data corresponding to reference physical characteristic information associated with a reference model of the candidate product 190 (step 330). As pointed out above, in some aspects, the reference physical characteristic information is electronic data that is associated with at least one image of a reference product (identical to the candidate product 190) that is captured by the at least one sensor 130 during a scan of the reference product by the scanner 120 earlier in time relative to the scan of the candidate product 190. As mentioned above, in some aspects, the electronic data corresponding to the reference physical characteristic information associated with the reference model of each candidate product 190 is stored in the electronic database 140 in a form of a set of numerical values representing one or more fixed size vectors (e.g., 512-dim) associated with the reference products 190.

The method 300 of FIG. 3 further includes providing a processor-based computing device 150 in communication with the scanner 120, sensors 130 and 135, and/or the electronic database 140 (step 340). As explained above, based on the electronic data obtained from the scanner 120, sensors 130 and 135, and/or electronic database 140, the computing device 150 determines generates a high probability estimation of whether the label 195 of the candidate product 190 being scanned in the product-scanning area 115 of the self-checkout terminal 110 is the product that is actually associated with the candidate product 190 (or if ticket-switching is likely involved). To that end, the method 300 of FIG. 3 includes obtaining, by the computing device 150, electronic data corresponding to actual identifying characteristic information associated with a candidate product 190 (step 350). As mentioned above, in some aspects, the actual identifying characteristic information is electronic data that is associated with at least one image of the candidate product 190 that captured by the at least one sensor 130 at a time of a scan of the candidate product 190 by the scanner 120. This electronic data may be relating to the physical size and shape of one or more sides of the candidate product 190, or may relate to any packaging-related characteristics (e.g., color, printed text, etc.) of the candidate product 190.

After the above-mentioned electronic data is obtained by the computing device 150, the method 300 of FIG. 3 further includes correlating, by the computing device 150, the electronic data corresponding to the actual identifying characteristic information associated with the candidate product 190 obtained by the at least one sensor 130 during the scan of the candidate product 190 by the scanner 120 to the electronic data corresponding to the reference physical characteristic information associated with the reference product 190 in order to generate a similarity score between the actual identifying characteristic information and the reference physical characteristic information (step 360). In addition, the method 300 includes determining, via the computing device 150, whether the correlation of the actual identifying characteristic information associated with the candidate product 190 to the reference physical characteristic information associated with the reference product indicates that the similarity score between the actual identifying characteristic information associated with the candidate product 190 and the reference physical characteristic information associated with the reference product 190 is above or below the predetermined similarity threshold (step 370).

As pointed out above, the correlation step 360 and the determining step 370 enable enables the control circuit 210 of the computing device 150 to determine whether the similarity score of the candidate product 190 is above or below a predetermined similarity threshold that is predetermined to be indicative of ticket-switching. If the similarity score of the candidate product 190 is above a predetermined similarity threshold that is predetermined to be indicative of ticket-switching, the computing device 150 estimates that there is no ticket-switching involved, and the method 300 includes permitting the self-checkout terminal 110 to process a purchase of the candidate product 190 (step 380). On the other hand, if the similarity score of the candidate product 190 is below the predetermined similarity threshold that is predetermined to be indicative of ticket-switching, the computing device 150 estimates that there is ticket-switching involved, and the method 300 includes restricting the self-checkout terminal 110 from processing the purchase of the candidate product 190 (step 390).

As mentioned above, when the computing device 150 determines that the similarity score is below the predetermined similarity threshold, the computing device 150 transmits an alert signal to an electronic device of a worker at the retail store, prompting the worker to inspect the candidate product 190 that the customer is attempting to check out in the product-scanning area 115 of the self-checkout terminal 110 (i.e., to verify whether the label 195 scanned by the scanner 120 is actually the candidate product 190 with which this label 195 is actually associated, or whether there is ticket-switching (or some other error/anomaly) is involved). In some aspects, as mentioned above, in conj unction with generating the alert, the control circuit 210 of the computing device 150 is programmed to transmit a signal that causes the self-checkout terminal 110 to halt operations relating to the processing of the purchase of the candidate product 190, pending the manual verification by the chaperone.

If the chaperone verifies that the scanned label 195 actually corresponds to the candidate product 190 (i.e., no ticket-switching is involved), then the chaperone can enter, via the chaperone’s electronic device, an input indicating that the chaperone validated the identity of the candidate product 190, and the computing device 150 then transmits a control signal to the self-checkout terminal 110 to permit the self-checkout terminal 110 to process the purchase of the candidate product 190 the identity of which has been validated. On the other hand, if the input by the chaperone indicates that the scanned label 195 does not correspond to the candidate product 190 (i.e., ticket-switching may be involved), then the computing device 150 transmits a control signal to the self-checkout terminal 110 to restrict the self-checkout terminal 110 from processing the purchase of the non-valid candidate product 190. In other words, if the computing device 150 generates an alert indicative of possible ticket-switching with respect to a given candidate product 190 and halts operation of the self-checkout terminal 110, the self-checkout terminal 110 chaperone must clear the alert in order for the self-checkout terminal 110 to be able to fully process the purchase transaction of that product.

The systems and methods described herein advantageously detect ticket-switching at self-checkout terminals with a high degree of precision and present an effective mechanism to detect and prevent fraudulent activity at self-checkout terminals, which can serve as a deterrent of fraudulent activity and save the retailers millions/billions of dollars in revenue that is presently lost as a result of fraudulent activities at self-checkout terminals.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for detecting fraudulent activity at a self-checkout terminal of a retail store, the system comprising:
a scanner located proximate a product-scanning area of the self-checkout terminal and configured to scan an identifier of a candidate product located in the product-scanning area of the self-checkout terminal;
at least a first sensor located proximate the product-scanning area of the self-checkout terminal and configured to detect at least one physical characteristic of the candidate product located in the product-scanning area of the self-checkout terminal;
an electronic database configured to store at least one of:
electronic data corresponding to the identifier of the candidate product; and
electronic data corresponding to reference physical characteristic information associated with a reference model of the candidate product, the reference physical characteristic information associated with at least one image of a reference product, identical to the candidate product, captured by the at least one sensor during a scan of the reference product by the scanner; and
a processor-based computing device in communication with the at least one sensor and the electronic database, the computing device being configured to:
obtain electronic data corresponding to actual identifying characteristic information associated with a candidate product, the actual identifying characteristic information associated with at least one image of the candidate product captured by the at least one sensor at a time of a scan of the candidate product by the scanner;
correlate the electronic data corresponding to the actual identifying characteristic information associated with the candidate product obtained by the at least one sensor during the scan of the candidate product by the scanner to the electronic data corresponding to the reference physical characteristic information associated with the reference product in order to generate a similarity score between the actual identifying characteristic information and the reference physical characteristic information;
determine if a correlation of the actual identifying characteristic information associated with the candidate product to the reference physical characteristic information associated with the reference product indicates whether the similarity score between the actual identifying characteristic information associated with the candidate product and the reference physical characteristic information associated with the reference product is above or below a predetermined similarity threshold;
if the similarity score is above the predetermined similarity threshold, permit the self-checkout terminal to process a purchase of the candidate product; and
if the similarity score is below the predetermined similarity threshold, restrict the self-checkout terminal from processing the purchase of the candidate product.

2. The system of claim 1, wherein the scanner includes at least one of a motion-detecting sensor, a radio frequency identification (RFID) sensor, a barcode sensor.

3. The system of claim 1, wherein the at least one sensor includes at least one of a camera sensor, a photo sensor, an optical sensor, a depth sensor, an ultrasonic sensor, a capacitance sensor, a weight sensor, a volumetric sensor, and a size sensor.

4. The system of claim 1,
wherein, in response to a determination by the computing device that the electronic database does not include a reference model for the candidate product, the computing device is configured to initiate a conversion of the electronic data corresponding to the actual identifying characteristic information associated with a candidate product into electronic data corresponding to the reference model for the candidate product for use in subsequent scans of candidate products; and
wherein, after the conversion is complete, to transmit the electronic data corresponding to the reference model for the candidate product to the electronic database for storage.

5. The system of claim 1, wherein the electronic data corresponding to the reference physical characteristic information associated with the reference model of the candidate product is stored in a form of a set of numerical values representing at least one fixed size vector associated with the reference product, the at least one fixed size vector being an output of an encoding, via a neural network, of the at least one image of the reference product into the at least one fixed size vector associated with the reference product.

6. The system of claim 5, wherein, after the electronic data corresponding to actual identifying characteristic information associated with a candidate product is obtained by the computing device, the computing device is configured to:
encode the at least one image of the candidate product captured by the at least one sensor at a time of a scan of the candidate product by the scanner into a set of numerical values representing at least one fixed size vector associated with the candidate product; and
correlate aggregate average numerical values representing the at least one fixed size vector associated with the reference product to aggregate average numerical values representing the at least one fixed size vector associated with the candidate product in order to determine the similarity score indicative of how similar or dissimilar the numerical values representing the at least one fixed size vector associated with the candidate product are to the numerical values representing the at least one fixed size vector associated with the reference product.

7. The system of claim 6,
wherein the computing device is configured to analyze, via a scoring neural network, the at least one fixed size vector associated with the candidate product, and to generate an image quality score indicative of an overall quality of the at least one image of the candidate product captured by the at least one sensor at the time of the scan of the candidate product by the scanner;
wherein, when the computing device determines that the image quality score of the at least one image of the candidate product is above a predetermined image quality threshold, the computing device is configured to correlate the aggregate average numerical values representing the at least one fixed size vector associated with the reference product to the aggregate average numerical values representing the at least one fixed size vector associated with the at least one image of the candidate product in order to determine the similarity score; and
wherein, when the computing device determines that the image quality score of the at least one image of the candidate product is below the predetermined image quality threshold, the computing device is configured to discard the at least one image of the candidate product.

8. The system of claim 7, wherein based on the correlation of the actual identifying characteristic information associated with the candidate product to the reference physical characteristic information associated with the reference product, the computing device is configured to:
calculate a minimum similarity threshold of the at least one image of the candidate product to the at least one image of the reference product, a maximum similarity threshold of the at least one image of the candidate product to the at least one image of the reference product, and a difference between the maximum similarity and the minimum similarity;
in response to a determination by the control circuit of the computing device that the difference between the maximum similarity and the minimum similarity is greater than the predetermined similarity threshold, the control circuit of the computing device is programmed to interpret this determination as an indication of fraudulent activity at the self-checkout terminal, and to not update the electronic database to replace the at least one image of the reference product with the at least one image of the candidate product;
in response to a determination by the control circuit of the computing device that the difference between the maximum similarity and the minimum similarity is less than the predetermined similarity threshold, the control circuit of the computing device is programmed to generate an alert signal to an electronic device of a worker at the retail store, the alert signal tasking the worker to manually confirm whether the electronic database is to be updated to replace the at least one image of the reference product with the at least one image of the candidate product; and
after a determination by the worker that the electronic database is to be updated, the control circuit of the computing device is programmed to cause the electronic database to be updated by replacing the at least one image of the reference product with the at least one image of the candidate product.

9. The system of claim 1, wherein the computing device is configured, in response to a determination, by the computing device, that the similarity score is below the predetermined similarity threshold, to cause transmission of an alert signal to an electronic device of a worker at the retail store.

10. The system of claim 9, wherein in response to receipt of an input by the worker indicating that the worker validated the identity of the candidate product, to transmit a control signal to the self-checkout terminal in order to permit the self-checkout terminal to process the purchase of the candidate product the identity of which has been validated.

11. A method of detecting fraudulent activity at a self-checkout terminal of a retail store, the method comprising:
scanning, via a scanner located proximate a product-scanning area of the self-checkout terminal, an identifier of a candidate product located in the product-scanning area of the self-checkout terminal;
detecting, via a first sensor located proximate the product-scanning area of the self-checkout terminal, at least one physical characteristic of the candidate product located in the product-scanning area of the self-checkout terminal;
providing an electronic database configured to store at least one of:
electronic data corresponding to the identifier of the candidate product; and
electronic data corresponding to reference physical characteristic information associated with a reference model of the candidate product, the reference physical characteristic information associated with at least one image of a reference product, identical to the candidate product, captured by the at least one sensor during a scan of the reference product by the scanner;
providing a processor-based computing device in communication with the at least one sensor and the electronic database;
obtaining, by the computing device, electronic data corresponding to actual identifying characteristic information associated with a candidate product, the actual identifying characteristic information associated with at least one image of the candidate product captured by the at least one sensor at a time of a scan of the candidate product by the scanner;
correlating, by the computing device, the electronic data corresponding to the actual identifying characteristic information associated with the candidate product obtained by the at least one sensor during the scan of the candidate product by the scanner to the electronic data corresponding to the reference physical characteristic information associated with the reference product in order to generate a similarity score between the actual identifying characteristic information and the reference physical characteristic information;
determining, via the computing device, if a correlation of the actual identifying characteristic information associated with the candidate product to the reference physical characteristic information associated with the reference product indicates whether the similarity score between the actual identifying characteristic information associated with the candidate product and the reference physical characteristic information associated with the reference product is above or below a predetermined similarity threshold;
permitting the self-checkout terminal to process a purchase of the candidate product in response to a determination by the computing device that the similarity score is above the predetermined similarity threshold; and
restricting the self-checkout terminal from processing the purchase of the candidate product in response to a determination by the computing device that the similarity score is below the predetermined similarity threshold.

12. The method of claim 11, wherein the scanner includes at least one of a motion-detecting sensor, a radio frequency identification (RFID) sensor, a barcode sensor.

13. The method of claim 11, wherein the at least one sensor includes at least one of a camera sensor, a photo sensor, an optical sensor, a depth sensor, an ultrasonic sensor, a capacitance sensor, a weight sensor, a volumetric sensor, and a size sensor.

14. The method of claim 11,
initiating, by the computing device and in response to a determination by the computing device that the electronic database does not include a reference model for the candidate product, a conversion of the electronic data corresponding to the actual identifying characteristic information associated with a candidate product into electronic data corresponding to the reference model for the candidate product for use in subsequent scans of candidate products; and
after the conversion is complete, transmitting the electronic data corresponding to the reference model for the candidate product from the computing device to the electronic database for storage.

15. The method of claim 11, further comprising storing the electronic data corresponding to the reference physical characteristic information associated with the reference model of the candidate product in a form of a set of numerical values representing at least one fixed size vector associated with the reference product, the at least one fixed size vector being an output of an encoding, via a neural network, of the at least one image of the reference product into the at least one fixed size vector associated with the reference product.

16. The method of claim 15, further comprising, after the electronic data corresponding to actual identifying characteristic information associated with a candidate product is obtained by the computing device:
encoding, by the computing device, the at least one image of the candidate product captured by the at least one sensor at a time of a scan of the candidate product by the scanner into a set of numerical values representing at least one fixed size vector associated with the candidate product; and
correlating, by the computing device, aggregate average numerical values representing the at least one fixed size vector associated with the reference product to aggregate average numerical values representing the at least one fixed size vector associated with the candidate product in order to determine the similarity score indicative of how similar or dissimilar the numerical values representing the at least one fixed size vector associated with the candidate product are to the numerical values representing the at least one fixed size vector associated with the reference product.

17. The method of claim 16, further comprising:
analyzing, by the computing device and via a scoring neural network, the at least one fixed size vector associated with the candidate product, and to generate an image quality score indicative of an overall quality of the at least one image of the candidate product captured by the at least one sensor at the time of the scan of the candidate product by the scanner;
when the computing device determines that the image quality score of the at least one image of the candidate product is above a predetermined image quality threshold, correlating, by the computing device, the aggregate average numerical values representing the at least one fixed size vector associated with the reference product to the aggregate average numerical values representing the at least one fixed size vector associated with the at least one image of the candidate product in order to determine the similarity score; and
when the computing device determines that the image quality score of the at least one image of the candidate product is below the predetermined image quality threshold, discarding the at least one image of the candidate product.

18. The method of claim 17, further comprising, based on the correlation of the actual identifying characteristic information associated with the candidate product to the reference physical characteristic information associated with the reference product, and by the control circuit of the computing device:
calculating a minimum similarity threshold of the at least one image of the candidate product to the at least one image of the reference product, a maximum similarity threshold of the at least one image of the candidate product to the at least one image of the reference product, and a difference between the maximum similarity and the minimum similarity;
in response to a determination by the control circuit of the computing device that the difference between the maximum similarity and the minimum similarity is greater than the predetermined similarity threshold, interpreting this determination as an indication of fraudulent activity at the self-checkout terminal, and not updating the electronic database to replace the at least one image of the reference product with the at least one image of the candidate product;
in response to a determination by the control circuit of the computing device that the difference between the maximum similarity and the minimum similarity is less than the predetermined similarity threshold, generating an alert signal to an electronic device of a worker at the retail store, the alert signal tasking the worker to manually confirm whether the electronic database is to be updated to replace the at least one image of the reference product with the at least one image of the candidate product; and
after a determination by the worker that the electronic database is to be updated, causing the electronic database to be updated by replacing the at least one image of the reference product with the at least one image of the candidate product.

19. The method of claim 11, further comprising causing, by the computing device, a transmission of an alert signal to an electronic device of a worker at the retail store in response to a determination, by the computing device, that the similarity score is below the predetermined similarity threshold.

20. The method of claim 19, further comprising, in response to receipt of an input by the worker indicating that the worker validated the identity of the candidate product, transmitting a control signal to the self-checkout terminal in order to permit the self-checkout terminal to process the purchase of the candidate product the identity of which has been validated.
